(19) United States
(12) Patent Application Publication
(10) Pub. No.: US 2017/0255274 A1
(43) Pub. Date: Sep. 7, 2017

(54) TIBETAN INPUT METHOD AND SYSTEM

(71) Applicant: Nima ZHAXI, Lhasa City (CN)

(72) Inventors: Nima Zhaxi, Lhasa City (CN); Qun Nuo, Lhasa City (CN); Yong Cuo, Lhasa City (CN); Pu Dun, Lhasa City (CN)

(21) Appl. No.: 15/338,071

(22) Filed: Oct. 28, 2016

(30) Foreign Application Priority Data
Mar. 6, 2016 (CN) 201610130611.7

(51) Int. Cl. G06F 3/01; G06F 3/02; G06F 3/023

(52) U.S. Cl. CPC G06F 3/018; G06F 3/023; G06F 3/0219

(57) ABSTRACT

A Tibetan input method and system relates to a character input method having an input module, including 47 input keys and used for inputting Tibetan characters; a keyboard definition module, including a plurality of storage units, each storage unit corresponding to one input key, and stores one or more Tibetan characters; when each storage unit stores a plurality of Tibetan characters, a preset ambiguous layout rule is satisfied; a Tibetan font, used for storing pre-combined Tibetan characters; and a processing device, which is respectively connected with the input module, the keyboard definition module and the Tibetan font, and is used for obtaining initial Tibetan characters corresponding to the input keys according to the keyboard definition module when the user inputs the Tibetan characters through the input keys, determining a target pre-combined Tibetan character according to the initial Tibetan characters and the Tibetan font, and outputting the target pre-combined Tibetan character.

### CROSS-REFERENCE TO RELATED APPLICATIONS

This application claims the benefit and priority of Chinese Patent Application No. 201610130611.7 filed Mar. 6, 2016. The entire disclosure of the above application is incorporated herein by reference.

### FIELD

The present disclosure relates to a character input method, and in particular, to a Tibetan input method and system.

### BACKGROUND

This section provides background information related to the present disclosure, which is not necessarily prior art.

Tibetan language belongs to the Tibetan branch of the Tibeto-Burman branch of the

Sino-Tibetan family, and is mainly distributed in Tibet, Qinghai, Sichuan, Gansu and Yunnan in China, as well as Pakistan, India, Nepal, Bhutan and other countries and regions. The Tibetan is an ancient phonetic writing that has a history of more than 1300 years, and is a written form of the Tibetan language. The Tibetan is widely used by more than 7 million people.

At present, the Tibetan input mode includes input according to Tibetan characters; wherein the input according to the Tibetan characters is divided into three situations: one is that one Tibetan character corresponds to one key position, the other is that one Tibetan character corresponds to a plurality of key positions, and the third situation is that a plurality of common Tibetan characters correspond to a shift key position of a keyboard.

However, when one Tibetan character corresponds to one key position, although the Tibetan input method has no repeated code, it contains a large number of redundant codes, namely dead keys; when one Tibetan character corresponds to a plurality of key positions, although it is easy to remember, there are repeated codes; and when a plurality of common Tibetan characters correspond to the shift key position of the keyboard, although there is no repeated code, a large number of shift key positions are present, so the Tibetan input efficiency is relatively low.

### SUMMARY

This section provides a general summary of the disclosure, and is not a comprehensive disclosure of its full scope or all of its features.

The present disclosure provides a Tibetan input method and system, in which there is no redundant code, repeated codes can be avoided, and the Tibetan input efficiency can be improved.

The present disclosure adopts the following technical solution to solve the technical problem: a Tibetan input system, including:

an input module, including 47 input keys and used by a user for inputting Tibetan characters;

a keyboard definition module, including a plurality of storage units, wherein each storage unit corresponds to one input key, and stores one or more Tibetan characters; when each storage unit stores a plurality of Tibetan characters, a preset ambiguous layout rule is satisfied;

a Tibetan font, used for storing pre-combined Tibetan characters; and

a processing device, which is respectively connected with the input module, the keyboard definition module and the Tibetan font, and is used for obtaining initial Tibetan characters corresponding to the input keys according to the keyboard definition module when the user inputs the Tibetan characters through the input keys, determining a target pre-combined Tibetan character according to the initial Tibetan characters and the Tibetan font, and outputting the target pre-combined Tibetan character.

Optionally, in the Tibetan input system provided by the embodiments of the present disclosure, the processing device includes:

a mapping module, used for obtaining the initial Tibetan characters corresponding to the input keys according to the keyboard definition module when the user inputs the Tibetan characters through the input keys;

a first storage module, connected with the mapping module, and used for storing the initial Tibetan characters;

a search processing module, connected with the first storage module, and used for using the initial Tibetan character as the target pre-combined Tibetan character when one initial Tibetan character exists, and outputting the target pre-combined Tibetan character; and

the search processing module is further used for obtaining the Tibetan characters that are input in front of or behind the initial Tibetan characters when a plurality of initial Tibetan characters exist, searching the Tibetan font according to the Tibetan characters that are input in front of or behind the initial Tibetan characters and the initial Tibetan characters, determining the target pre-combined Tibetan character from the plurality of initial Tibetan characters, and outputting the target pre-combined Tibetan character.

Optionally, in the Tibetan input system provided by the embodiments of the present disclosure, the preset ambiguous layout rule includes:

Tibetan superscripts and Tibetan radicals correspond to two storage units;

Tibetan subscripts and Tibetan postscripts correspond to two storage units;

when the intersection of a set consisting of all prescripts of the Tibetan superscripts and a set consisting of all radicals of the Tibetan subscripts is a null set, the Tibetan superscripts and the Tibetan subscripts can correspond to one storage unit;

when Tibetan consonants cannot be spelled with the prescripts and the Tibetan consonants cannot be used as the postscripts, the Tibetan consonants and Tibetan vowels can correspond to one storage unit; and

when the intersection of a set consisting of all prescripts of other Tibetan radicals excluding the Tibetan radicals corresponding to the consonants that can be used as the postscripts and a set consisting of all radicals of the Tibetan subscripts is a null set, the other Tibetan radicals and the Tibetan subscripts can correspond to one storage unit.

Optionally, in the Tibetan input system provided by the embodiments of the present disclosure, the Tibetan consonant [symbol] and the Tibetan subscript [symbol] correspond to one storage unit, the Tibetan consonant [symbol] and the Tibetan vowel [symbol] correspond to one storage unit, the Tibetan consonant [symbol] and the Tibetan vowel [symbol] correspond to one storage unit, the Tibetan consonant [symbol] and the Tibetan vowel [symbol] correspond to one storage unit, the Tibetan consonant [symbol] and the Tibetan subscript [symbol] correspond to one storage unit, the Tibetan consonant [symbol] and the Tibetan subscript [symbol] correspond to one storage unit, the Tibetan consonant [symbol] and the Tibetan subscript [symbol] correspond to one storage unit, and the Tibetan consonant [symbol] and the Tibetan subscript [symbol] correspond to one storage unit.

Optionally, in the Tibetan input system provided by the embodiments of the present disclosure, among the other Tibetan characters excluding the Tibetan consonant [symbol] , the Tibetan subscript [symbol] , the Tibetan consonant [symbol] , the Tibetan vowel [symbol] , the Tibetan consonant [symbol] , the Tibetan vowel [symbol] , the Tibetan consonant [symbol] , the Tibetan vowel [symbol] , the Tibetan consonant [symbol] , the Tibetan subscript [symbol] , the Tibetan consonant [symbol] , the Tibetan subscript [symbol] , the Tibetan consonant [symbol] , the Tibetan subscript [symbol] , the Tibetan consonant [symbol] and the Tibetan subscript [symbol] , each Tibetan character corresponds to one storage unit.

Optionally, in the Tibetan input system provided by the embodiments of the present disclosure, the input module is further used by the user for inputting an instruction;

the storage unit further stores an instruction character, and the instruction character includes one or more of a control character Ctrl, an alternate shift character Alt, a shift conversion character Shift, a carriage return character Enter, a backspace character Backspace, a tab character Tab and a capslock character Capslock; and

the processing device is further used for obtaining the instruction character corresponding to the input key according to the keyboard definition module when the user inputs the instruction through the input key, and executing the instruction corresponding to the instruction character.

The present disclosure adopts the following technical solution to solve the technical problem: a Tibetan input method, including: S10, detecting whether a plurality of preset input keys are pressed down; S20, when the input keys are pressed down, obtaining initial Tibetan characters corresponding to the input keys according to a preset keyboard definition module, wherein the keyboard definition module includes a plurality of storage units, each storage unit corresponds to one input key, and stores one or more Tibetan characters; when each storage unit stores a plurality of Tibetan characters, a preset ambiguous layout rule is satisfied; and S30, determining a target pre-combined Tibetan character according to the initial Tibetan characters and a preset Tibetan font, and outputting the target pre-combined Tibetan character.

Optionally, in the Tibetan input method provided by the embodiments of the present disclosure, the S30 includes: S301, judging whether one or a plurality of initial Tibetan characters exist; when one initial Tibetan character exists, executing S302; when a plurality of initial Tibetan characters exist, executing S303; S302, using the initial Tibetan character as the target pre-combined Tibetan character and outputting the target pre-combined Tibetan character; S303, obtaining the Tibetan characters that are input in front of or behind the initial Tibetan characters; and S304, searching the Tibetan font according to the Tibetan characters that are input in front of or behind the initial Tibetan characters and the initial Tibetan characters, determining the target pre-combined Tibetan character from the plurality of initial Tibetan characters, and outputting the target pre-combined Tibetan character.

Optionally, in the Tibetan input method provided by the embodiments of the present disclosure, the preset ambiguous layout rule includes: Tibetan superscripts and Tibetan radicals correspond to two storage units; Tibetan subscripts and Tibetan postscripts correspond to two storage units; when the intersection of a set consisting of all prescripts of the Tibetan superscripts and a set consisting of all radicals of the Tibetan subscripts is a null set, the Tibetan superscripts and the Tibetan subscripts can correspond to one storage unit; when Tibetan consonants cannot be spelled with the prescripts and the Tibetan consonants cannot be used as the postscripts, the Tibetan consonants and Tibetan vowels can correspond to one storage unit; and when the intersection of a set consisting of all prescripts of other Tibetan radicals excluding the Tibetan radicals corresponding to the consonants that can be used as the postscripts and a set consisting of all radicals of the Tibetan subscripts is a null set, the other Tibetan radicals and the Tibetan subscripts can correspond to one storage unit.

Optionally, in the Tibetan input method provided by the embodiments of the present disclosure, the Tibetan consonant [symbol] and the Tibetan subscript [symbol] correspond to one storage unit, the Tibetan consonant [symbol] and the Tibetan vowel [symbol] correspond to one storage unit, the Tibetan consonant [symbol] and the Tibetan vowel [symbol] correspond to one storage unit, the Tibetan consonant [symbol] and the Tibetan vowel [symbol] correspond to one storage unit, the Tibetan consonant [symbol] and the Tibetan subscript [symbol] correspond to one storage unit, the Tibetan consonant [symbol] and the Tibetan subscript [symbol] correspond to one storage unit, the Tibetan consonant [symbol] and the Tibetan subscript [symbol] correspond to one storage unit, and the Tibetan consonant [symbol] and the Tibetan subscript [symbol] correspond to one storage unit.

The present disclosure has the following beneficial effects: when the user inputs the Tibetan characters through the input keys, the initial Tibetan characters corresponding to the input keys are obtained according to the keyboard definition module; and the target pre-combined Tibetan character is determined according to the initial Tibetan characters and the Tibetan font, and then is output. According to the technical solutions provided by the embodiments of the present disclosure, when each storage unit stores a plurality of Tibetan characters, the preset ambiguous layout rule is satisfied, therefore the input module has no redundant code and repeated code, and only 6 very common Tibetan characters correspond to the shift key. Thus, the following problems in the prior art are solved: when one Tibetan character corresponds to one key position, although the Tibetan input method has no repeated code, it contains a large number of redundant codes, namely dead keys; when one Tibetan character corresponds to a plurality of key positions, although it is easy to remember, there are repeated codes; and when a plurality of common Tibetan characters correspond to the shift key position of the keyboard, although there is no repeated code, a large number of shift key positions are present, so the Tibetan input efficiency is relatively low.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram of a structure of a Tibetan input system provided by a first embodiment of the present disclosure;

FIG. 2 is a schematic diagram of a structure of a processing device in the Tibetan input system as shown in FIG. 1;

FIG. 3 is a schematic diagram of an input module in the Tibetan input system as shown in FIG. 1;

FIG. 4 is a flowchart of a Tibetan input method provided by a second embodiment of the present disclosure.

### DETAILED DESCRIPTION

The technical solutions of the present disclosure will be further illustrated below in combination with embodiments and accompanying drawings.

First embodiment

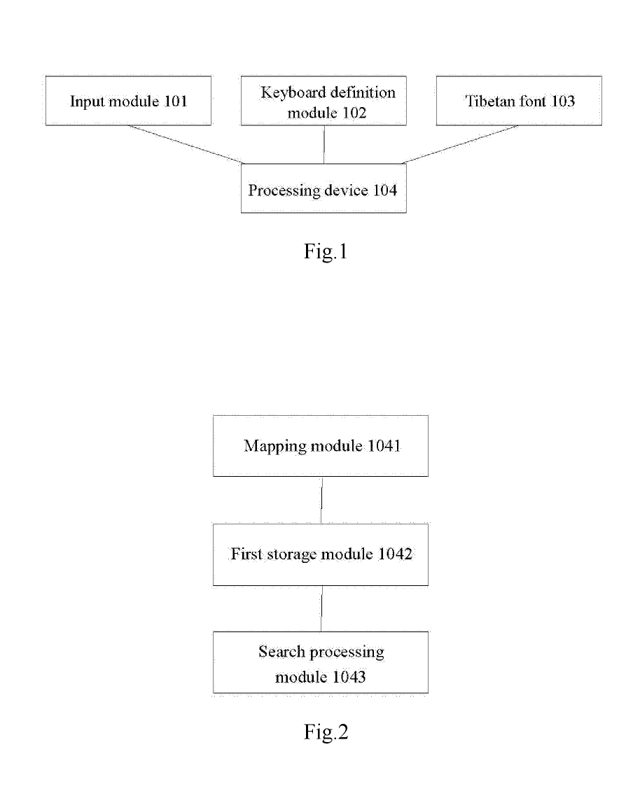

As shown in FIG. 1, the embodiment of the present disclosure provides a Tibetan input system, including:

an input module 101, including 47 input keys and used by a user for inputting Tibetan characters;

a keyboard definition module 102, including a plurality of storage units, wherein each storage unit corresponds to one input key, and stores one or more Tibetan characters; when each storage unit stores a plurality of Tibetan characters, a preset ambiguous layout rule is satisfied;

a Tibetan font 103, used for storing pre-combined Tibetan characters; and

a processing device 104, which is respectively connected with the input module, the keyboard definition module and the Tibetan font, and is used for obtaining initial Tibetan characters corresponding to the input keys according to the keyboard definition module when the user inputs the Tibetan characters through the input keys, determining a target pre-combined Tibetan character according to the initial Tibetan characters and the Tibetan font, and outputting the target pre-combined Tibetan character.

In the embodiment, the processing device 104 includes: a mapping module 1041, used for obtaining the initial Tibetan characters corresponding to the input keys according to the keyboard definition module when the user inputs the Tibetan characters through the input keys;

a first storage module 1042, connected with the mapping module, and used for storing the initial Tibetan characters;

a search processing module 1043, connected with the first storage module, and used for using the initial Tibetan character as the target pre-combined Tibetan character when one initial Tibetan character exists, and outputting the target pre-combined Tibetan character; and

the search processing module is further used for obtaining the Tibetan characters that are input in front of or behind the initial Tibetan characters when a plurality of initial Tibetan characters exist, searching the Tibetan font according to the Tibetan characters that are input in front of or behind the initial Tibetan characters and the initial Tibetan characters, determining the target pre-combined Tibetan character from the plurality of initial Tibetan characters, and outputting the target pre-combined Tibetan character.

The process of searching the Tibetan font according to the Tibetan characters that are input in front of or behind the initial Tibetan characters and the initial Tibetan characters and determining the target pre-combined Tibetan character from the plurality of initial Tibetan characters includes: searching the Tibetan font according to a Tibetan character string consisting of the Tibetan characters that are input in front of or behind the initial Tibetan characters and the initial Tibetan characters, and determining the target pre-combined Tibetan character that is coded corresponding to the Tibetan character string from the Tibetan font.

In the embodiment, the preset ambiguous layout rule indicates that if the storage unit stores a plurality of Tibetan scripts, only one Tibetan script can be output. Specifically, the preset ambiguous layout rule includes: Tibetan superscripts and Tibetan radicals correspond to two storage units; Tibetan subscripts and Tibetan postscripts correspond to two storage units; when the intersection of a set consisting of all prescripts of the Tibetan superscripts and a set consisting of all radicals of the Tibetan subscripts is a null set, the Tibetan superscripts and the Tibetan subscripts can correspond to one storage unit; when Tibetan consonants cannot be spelled with the prescripts and the Tibetan consonants cannot be used as the postscripts, the Tibetan consonants and Tibetan vowels can correspond to one storage unit; and when the intersection of a set consisting of all prescripts of other Tibetan radicals excluding the Tibetan radicals corresponding to the consonants that can be used as the postscripts and a set consisting of all radicals of the Tibetan subscripts is a null set, the other Tibetan radicals and the Tibetan subscripts can correspond to one storage unit.

Optionally, in the Tibetan input method provided by the embodiment of the present disclosure, the ambiguous layout rule conforms to the following Tibetan spelling grammar; for the convenience of subsequent description, 30 Tibetan consonants and 5 reverse scripts are respectively mapped to b1 to b35 representation symbols, 4 vowels are respectively mapped to English letters i, u, e, o, and l long vowel is mapped to an English letter a. The following table shows a mapping relation of the Tibetan characters and the representation symbols.

Mapping table of the Tibetan characters and the representation symbols

| Tibetan | Representation |
|---|---|
| script | symbol |
| [symbol] | b₁ |
| [symbol] | b₂ |
| [symbol] | b₃ |
| [symbol] | b₄ |
| [symbol] | b₅ |
| [symbol] | b₆ |
| [symbol] | b₇ |
| [symbol] | b₈ |
| [symbol] | b₉ |
| [symbol] | b₁₀ |
| [symbol] | b₁₁ |
| [symbol] | b₁₂ |
| [symbol] | b₁₃ |
| [symbol] | b₁₄ |
| [symbol] | b₁₅ |
| [symbol] | b₁₆ |
| [symbol] | b₁₇ |
| [symbol] | b₁₈ |
| [symbol] | b₁₉ |
| [symbol] | b₂₀ |
| [symbol] | b₂₁ |
| [symbol] | b₂₂ |
| [symbol] | b₂₃ |
| [symbol] | b₂₄ |
| [symbol] | b₂₅ |
| [symbol] | b₂₆ |
| [symbol] | b₂₇ |
| [symbol] | b₂₈ |
| [symbol] | b₂₉ |
| [symbol] | b₃₀ |
| [symbol] | b₃₁ |
| [symbol] | b₃₂ |
| [symbol] | b₃₃ |
| [symbol] | b₃₄ |
| [symbol] | b₃₅ |

Tibetan spelling grammar 1: elements in a set Root={b₁, b₂, b₃, b₄, b₅, . . . . , b₃₀, b₃₁, b₃₂, b₃₃, b₃₄, b₃₅} respectively correspond to 30 Tibetan consonants and 5 Tibetan reverse scripts, and then any Tibetan character corresponding to b₁. Root can constitute the radical of the Tibetan character.

Tibetan spelling grammar 2: for a set Prefix={b₃, b₁₁, b₁₅, b₁₆, b₂₃}, Prefix Root, any Tibetan character corresponding to bᵢ, Prefix, (j=3, 11, 15, 16, 23) can constitute the prescript of the Tibetan character.

Tibetan spelling grammar 3: for a set Suffix={b₃, b₄, b₁₁, b₁₂, b₁₅, b₁₆, b₂₃, b₂₅, b₂₆, b₂₈}, Suffix Root, any Tibetan character corresponding to bᵢ, Suffix, (j=3, 4, 11, 12, 15, 16, 23, 25, 26, 28) can constitute the postscript of the Tibetan character.

Tibetan spelling grammar 4: for a set Postfix={b₁₁, b₂₈}, Postfix Suffix Root, any Tibetan character corresponding to bᵢ, Postfix, (j=11, 28) can constitute a post-postscript of the Tibetan character.

Tibetan spelling grammar 5: for a set Superfix={b₂₅, b₂₆, b₂₈}, Superfix Root, any Tibetan character corresponding to bᵢ, Superfix, (j=25, 26, 28) can constitute the superscript of the Tibetan character.

Tibetan spelling grammar 6: for a set Subfix={b₂₀, b₂₄, b₂₅, b₂₆}, Subfix Root, any Tibetan character corresponding to bᵢ, Subfix, (j=20, 24, 25, 26) can constitute the subscript of the Tibetan character.

Tibetan spelling grammar 7: for a set Vowel=Vowel1{a}, Vowel1={i, u, e, o} corresponds to 4 Tibetan vowels, and a represents the Tibetan long vowel. The Tibetan radicals corresponding to bⱼ, Root, (j=1, 23, 5, 7, . . . 33, 34, 35) can be spelled with the vowels corresponding to v, Vowel, u and a can only be spelled below the consonants, and the rest 3 vowels can only be spelled above the consonants.

Tibetan spelling grammar 8: when the Tibetan radicals corresponding to bⱼ, Root, (j=1, 3, 4, 5, 7, 8, 9, 11, 12, 13, 15, 16, 17, 19, 29) are spelled with the superscripts corresponding to bᵢ, Superfix, (i=25, 26, 28), the following grammar rules must be satisfied:

1. bⱼ, Root, (j=1, 3, 4, 7, 8, 9, 11, 12, 15, 16, 17, 19) can only be spelled with b₂₅, Superfix.

2. bⱼ, Root, (j=1, 3, 4, 5, 7, 9, 11, 13, 15, 29) can only be spelled with b₂₆, Superfix.

3. bⱼ, Root, (j=1, 3, 4, 8, 9, 11, 12, 13, 15, 16, 17) can only be spelled with b₂₈, Superfix.

Tibetan spelling grammar 9: when the Tibetan radicals corresponding to bⱼ, Root, (j=1, 2, 3, 8, 9, 10, 11, 13, 14, 15, 16, 18, 21, 22, 25, 26, 27, 28, 29) are spelled with the subscripts corresponding to bᵢ, Subfix, (i=20, 24, 25, 26), the following grammar rules must be satisfied:
1. bⱼ, Root, (j=1, 2, 3, 8, 11, 18, 21, 22, 25, 26, 27, 29) can only be spelled with bₘ

Subfix.

2. bⱼ, Root, (j=1, 2, 3, 13, 14, 15, 16) can only be spelled with b₂₄, Subfix.

3. bⱼ, Root, (j=1, 2, 3, 9, 10, 11, 13, 14, 15, 16, 28, 29) can only be spelled with b₂₅,

### Subfix.

4. bⱼ, Root, (j=1, 3, 15, 22, 25, 28) can only be spelled with b₂₆, Subfix.

5. bⱼ, Root, (j=29) can only be spelled with b₁₄, Subfix.

(Note: to spell the [f] phonetic symbol in other languages, b₂₉ and b₁₄ spelling forms occur in the modern Tibetan. According to the traditional Tibetan spelling grammar, b₂₉ cannot be used as the superscript, and b₁₄ cannot be used as the subscript neither, therefore, as a special condition, when b₂₉ is spelled with b₁₄, b₁₄ is deemed as the “subscript”.)

Tibetan spelling grammar 10: when the Tibetan radicals corresponding to bᵢ, Root, (i=1, 3, 12, 13, 15, 16, 17) are simultaneously spelled with the superscripts corresponding to bⱼ, Superfix, (j=25, 28) and the subscripts corresponding to bₖ, Subfix, (k=20, 24, 25), the following grammar rules must be satisfied:

1. When being spelled with b₂₅, Superfix, b₁, Root can be simultaneously spelled with b₂₄, Subfix; and when being spelled with b₂₈, Superfix, b₁, Root can be simultaneously spelled with bₖ, Subfix, (k=24, 25).

2. When being spelled with b₂₅, Superfix, b₃, Root can be simultaneously spelled with b₂₄, Subfix; and when being spelled with b₂₈, Superfix, b₃, Root can be simultaneously spelled with bₖ, Subfix, (k=24, 25).

3. When being spelled with b₂₈, Superfix, b₁₂, Root can be simultaneously spelled with b₂₅, Subfix.

4. When being spelled with b₂₈, Superfix, b₁₃, Root can be simultaneously spelled with bₖ, Subfix, (k=24, 25).

5. When being spelled with b₂₈, Superfix, b₁₅, Root can be simultaneously spelled with bₖ, Subfix, (k=24, 25).

6. When being spelled with b₂₅, Superfix, b₁₆, Root can be simultaneously spelled with b₂₄, Subfix; and when being spelled with b₂₈, Superfix, b₁₆, Root can be simultaneously spelled with bₖ, Subfix, (k=24, 25).

7. When being spelled with b₂₅, Superfix, b₁₇, Root can be simultaneously spelled with b₂₀, Subfix.

Tibetan spelling grammar 11: when the Tibetan radicals corresponding to bᵢ, Root, (i=1, 3, 4, 7, 8, 9, 11, 12, 17, 19) are simultaneously spelled with the prescripts corresponding to b₁₅, Prefix and the superscripts corresponding to bⱼ, Superfix, (j=25, 26, 28), the following grammar rules must be satisfied:

1. bᵢ, Root, (i=1, 3, 4, 7, 8, 9, 11, 12, 17, 19) can be spelled with b₂₅, Superfix.

2. bᵢ, Root, (i=9,11) can be spelled with b₂₆, Superfix.

3. bᵢ, Root, (i=1, 3, 4, 8, 9, 11, 12, 17) can be spelled with b₂₈, Superfix.

Tibetan spelling grammar 12: when the Tibetan radicals corresponding to bᵢ, Root, (i=1, 2, 3, 11, 13, 14, 15, 16, 22, 25, 28) are simultaneously spelled with the prescripts corresponding to bⱼ, Prefix, (j=11, 15, 16, 23) and the subscripts corresponding to bₖ, Subfix, (k=20, 24, 25, 26), the following grammar rules must be satisfied:

1. bᵢ, Root, (i=1, 3, 13, 15, 16) can be spelled with b₁₁, Prefix and b₂₄, Subfix.

2. bᵢ, Root, (i=1, 3, 13, 15) can be spelled with b₁₁, Prefix and b₂₅, Subfix.

3. bᵢ, Root, (i=1, 3) can be spelled with b₁₅, Prefix and b₂₄, Subfix.

4. bᵢ, Root, (i=1, 3, 28) can be spelled with b₁₅, Prefix and b₂₅, Subfix.

5. bᵢ, Root, (i=1, 22, 25, 28) can be spelled with b₁₅, Prefix and b₂₆, Subfix.

6. bᵢ, Root, (i=2, 3) can be spelled with b₁₆, Prefix and bₖ Subfix, (k=24,25).

7. bᵢ, Root, (i=2, 3, 14, 15) can be spelled with b₂₃, Prefix and b₂₄, Subfix.

8. bᵢ, Root, (i=2, 3, 11, 14, 15) can be spelled with b₂₃, Prefix and b₂₅, Subfix.

Tibetan spelling grammar 13: when the Tibetan radicals corresponding to bᵢ, Root, (i=1, 3) are spelled with the prescripts corresponding to b₁₅, Prefix, the superscripts corresponding to bⱼ, Superfix, (i=25, 28) and the subscripts corresponding to bₖ, Subfix, (i=24, 25), the following grammar rules must be satisfied:

1. bᵢ, Root, (i=1, 3) can be spelled with b₁₅, Prefix, b₂₅, Superfix and b₂₄, Subfix.

2. bᵢ, Root, (i=1, 3) can be spelled with b₁₅, Prefix, b₂₈, Superfix and b₂₅, Subfix.

3. bᵢ, Root, (i=1, 3) can be spelled with b₁₅, Prefix, b₂₈, Superfix and b₂₄, Subfix.

Tibetan spelling grammar 14: when being spelled with the prescripts corresponding to bⱼ, Prefix, (j=3, 11, 15, 16, 23), the Tibetan radicals corresponding to bᵢ, Root, (i=1, 2, 3, 4, 5, 6, 7, 8, 9, 10, 11, 12, 13, 14, 15, 16, 17, 18, 19, 21, 22, 24, 27, 28) must be simultaneously spelled with the vowels corresponding to v. Vowel, Vowel={i, u, e, o}, or one postscript corresponding to bₖ, Suffix, (k=3, 4, 11, 12, 15, 16, 23, 25, 26, 28), and the following grammar rules must be satisfied:

1. bᵢ, Root, (i=5, 8, 9, 11, 12, 17, 21, 22, 24, 27, 28) can only be spelled with b₃, Prefix.

2. bᵢ, Root, (i=1, 3, 4, 13, 15, 16) can only be spelled with b₁₁, Prefix.

3. bᵢ, Root, (i=1, 3, 5, 9, 11, 17, 21, 22, 27, 28) can only be spelled with b₁₅, Prefix.

4. bᵢ, Root, (i=2, 3, 4, 6, 7, 8, 10, 11, 12, 18, 19) can only be spelled with b₁₆, Prefix.

5. bᵢ, Root, (i=2, 3, 6, 7, 10, 11, 14, 15, 18, 19) can only be spelled with b₂₃, Prefix.

Tibetan spelling grammar 15: the Tibetan radicals corresponding to bⱼ, Root, (j=1, 2, 3, 4, 5, 6, 7, 8, 9, 10, . . . , 21, 22, 23, 24, 25, 26, 27, 28, 29, 30) can be spelled with any postscript corresponding to bᵢ, Suffix, (i=3, 4, 11, 12, 15, 16, 23, 25, 26, 28).

Tibetan spelling grammar 16: the use of the Tibetan post-postscripts is only related to the postscripts. The Tibetan postscripts corresponding to bᵢ, Suffix, (i=3, 4, 12, 15, 16, 25, 26) can be spelled with the post-postscripts corresponding to bⱼ, Postfix, (j=11, 28), and the following grammar rules must be satisfied:

1. b₁₁, Postfix can only be spelled with bᵢ, Suffix, (i=12, 25, 26).

2. b₂₈, Postfix can only be spelled with bᵢ, Suffix, (i=3, 4, 15, 16).

Tibetan spelling grammar 17: when being spelled with the Tibetan subscripts corresponding to bⱼ, Subfix, (j=24, 25), the Tibetan radicals corresponding to bᵢ, Root, (i=3, 11, 14) can be simultaneously spelled with the Tibetan subscripts corresponding to b₂₀, Subfix. The specific rules are as follows:

1. when being spelled with b₂₅, Subfix, bᵢ, Root, (i=3, 11) can be simultaneously spelled with b₂₀, Subfix.

2. When being spelled with b₂₄, Subfix, b₁₄, Root can be simultaneously spelled with b₂₀, Subfix.

Tibetan spelling grammar 18: the Tibetan consonants corresponding to b₂₉, Root can be spelled with the Tibetan consonants corresponding to b₁₄, Root, and b₁₄, Root is correspondingly located below b₂₉, Root.

Tibetan spelling grammar 19: when being spelled with the Tibetan consonants corresponding to b₁₄, Root, the Tibetan consonants corresponding to b₂₉, Root can be simultaneously spelled with the Tibetan postscripts corresponding to bᵢ, Suffix, (i=3, 4, 11, 12, 15, 16, 23, 25, 26, 28).

Tibetan spelling grammar 20: the Tibetan characters having no postscript can be spelled with the Tibetan consonants corresponding to b₂₃, Root, and at this time, the Tibetan consonants corresponding to b₂₃, Root must be spelled with the vowels (i, e, u, o) corresponding to v Vowel, Vowel={i, u, e, o}.

Tibetan spelling grammar 21: except the special spelling in the grammars 17, 18, 19 and 20, the Tibetan characters are spelled according to the sequence of the prescripts, the superscripts, the radicals, the subscripts, the vowels, the postscripts and the post-postscripts.

Specifically, to satisfy the ambiguous layout rule, the layout of the input module of the Tibetan input device can be shown in FIG. 3, on the Tibetan input keys, the Tibetan consonant and the Tibetan subscript [symbol] correspond to one storage unit, the Tibetan consonant [symbol] and the Tibetan vowel [symbol] correspond to one storage unit, the Tibetan consonant [symbol] and the Tibetan vowel [symbol] correspond to one storage unit, the Tibetan consonant [symbol] and the Tibetan vowel [symbol] correspond to one storage unit, the Tibetan consonant [symbol] and the Tibetan subscript [symbol] correspond to one storage unit, the Tibetan consonant [symbol] and the Tibetan subscript [symbol] correspond to one storage unit, the Tibetan consonant [symbol] and the Tibetan subscript [symbol] correspond to one storage unit, and the Tibetan consonant [symbol] and the Tibetan subscript [symbol] correspond to one storage unit. The Tibetan subscript [symbol] is deformed into [symbol] when being written; the Tibetan subscript [symbol] is deformed into [symbol] when being written; and the Tibetan subscript [symbol] is deformed into [symbol] when being written.

At this time, as shown in FIG. 3, among the other Tibetan characters excluding the Tibetan consonant [symbol] , the Tibetan subscript [symbol] , the Tibetan consonant [symbol] , the Tibetan vowel [symbol] , the Tibetan consonant [symbol] , the Tibetan vowel [symbol] , the Tibetan consonant [symbol] , the Tibetan vowel [symbol] , the Tibetan consonant [symbol] , the Tibetan subscript [symbol] , the Tibetan consonant [symbol] , the Tibetan subscript [symbol] , the Tibetan consonant [symbol] , the Tibetan subscript [symbol] , the Tibetan consonant [symbol] , and the Tibetan subscript [symbol] , each Tibetan character corresponds to one storage unit.

To input an instruction, in the Tibetan input system provided by the embodiment of the present disclosure, the input module is further used by the user for inputting the instruction;

the storage unit further stores an instruction character, and the instruction character includes one or more of a control character Ctrl, an alternate shift character Alt, a shift conversion character Shift, a carriage return character Enter, a backspace character Backspace, a tab character Tab and a capslock character Capslock; and

the processing device is further used for obtaining the instruction character corresponding to the input key according to the keyboard definition module when the user inputs the instruction through the input key, and executing the instruction corresponding to the instruction character.

To input Chinese, English and other characters, the Tibetan input module can switch Tibetan input, Chinese input and English input through the keys, as well as switching through the instruction, and this is not limited herein.

The layout of the input keys of the input module in the Tibetan input system provided by the embodiment of the present disclosure can be shown in FIG. 3, other modes can also be available, as long as the storage unit satisfies the ambiguous layout rule.

In the embodiment, when the user needs to input characters beyond the pre-combined Tibetan characters stored in the Tibetan font, the processing device may not determine the target pre-combined Tibetan character, at this time, the processing device can prompt the user about all possible character combinations, and then input the characters beyond the pre-combined Tibetan characters stored in the Tibetan font according to the indication of the user.

The present disclosure has the following beneficial effects: when the user inputs the

Tibetan characters through the input keys, the initial Tibetan characters corresponding to the input keys are obtained according to the keyboard definition module; and the target pre-combined Tibetan character is determined according to the initial Tibetan characters and the Tibetan font, and then is output. According to the technical solutions provided by the embodiment of the present disclosure, when each storage unit stores a plurality of Tibetan characters, the preset ambiguous layout rule is satisfied, therefore the input module has no redundant code and repeated code, and only 6 very common Tibetan characters correspond to the shift key. Thus, the following problems in the prior art are solved: when one Tibetan character corresponds to one key position, although the Tibetan input method has no repeated code, it contains a large number of redundant codes, namely dead keys; when one Tibetan character corresponds to a plurality of key positions, although it is easy to remember, there are repeated codes; and when a plurality of common Tibetan characters correspond to the shift key position of the keyboard, although there is no repeated code, a large number of shift key positions are present, so the Tibetan input efficiency is relatively low.

### Second Embodiment

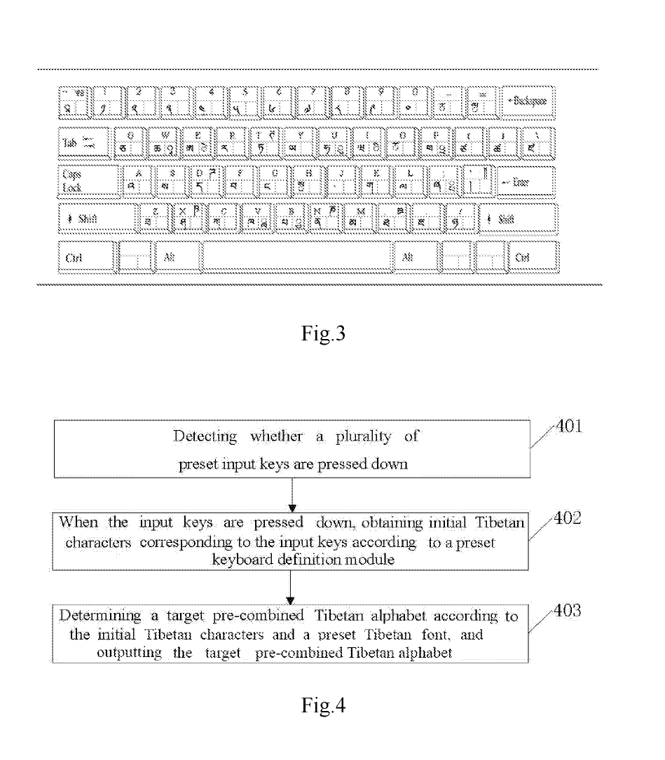

As shown in FIG. 4, the embodiment provides a Tibetan input method including the following steps:

Step 401, whether a plurality of preset input keys are pressed down is detected.

In the embodiment, the distribution mode of the plurality of input keys can be shown in FIG. 3, other modes can also be available, and will not be repeated redundantly herein.

Step 402, when the input keys are pressed down, initial Tibetan characters corresponding to the input keys are obtained according to a preset keyboard definition module.

In the embodiment, the structure and the function of the keyboard definition module are similar to those as shown in FIG. 1. The keyboard definition module includes a plurality of storage units, each storage unit corresponds to one input key, and stores one or more Tibetan characters; and when each storage unit stores a plurality of Tibetan characters, a preset ambiguous layout rule is satisfied. The ambiguous layout rule is similar to that provided in the first embodiment of the present disclosure, and includes: Tibetan superscripts and Tibetan radicals correspond to two storage units; Tibetan subscripts and Tibetan postscripts correspond to two storage units; when the intersection of a set consisting of all prescripts of the Tibetan superscripts and a set consisting of all radicals of the Tibetan subscripts is a null set, the Tibetan superscripts and the Tibetan subscripts can correspond to one storage unit; when Tibetan consonants cannot be spelled with the prescripts and the Tibetan consonants cannot be used as the postscripts, the Tibetan consonants and Tibetan vowels can correspond to one storage unit; and when the intersection of a set consisting of all prescripts of other Tibetan radicals excluding the Tibetan radicals corresponding to the consonants that can be used as the postscripts and a set consisting of all radicals of the Tibetan subscripts is a null set, the other Tibetan radicals and the Tibetan subscripts can correspond to one storage unit.

Optionally, in the Tibetan input method provided by the embodiment of the present disclosure, the Tibetan consonant [symbol] and the Tibetan subscript [symbol] correspond to one storage unit, the Tibetan consonant [symbol] and the Tibetan vowel [symbol] correspond to one storage unit, the Tibetan consonant [symbol] and the Tibetan vowel [symbol] correspond to one storage unit, the Tibetan consonant [symbol] and the Tibetan vowel [symbol] correspond to one storage unit, the Tibetan consonant [symbol] and the Tibetan subscript [symbol] correspond to one storage unit, the Tibetan consonant [symbol] and the Tibetan subscript [symbol] correspond to one storage unit, the Tibetan consonant [symbol] and the Tibetan subscript [symbol] correspond to one storage unit, and the Tibetan consonant [symbol] and the Tibetan subscript [symbol] correspond to one storage unit. No repetition will be given herein one by one.

Step 403, a target pre-combined Tibetan character is determined according to the initial Tibetan characters and a preset Tibetan font, and then is output.

In the embodiment, the process of determining the target pre-combined Tibetan character in the step S403 includes: judging whether one or a plurality of initial Tibetan characters exist; when one initial Tibetan character exists, using the initial Tibetan character as the target pre-combined Tibetan character and outputting the target pre-combined Tibetan character; when a plurality of initial Tibetan characters exist, obtaining the Tibetan characters that are input in front of or behind the initial Tibetan characters, searching the Tibetan font according to the Tibetan characters that are input in front of or behind the initial Tibetan characters and the initial Tibetan characters, determining the target pre-combined Tibetan character from the plurality of initial Tibetan characters, and outputting the target pre-combined Tibetan character.

In the embodiment, when the user needs to input characters beyond the pre-combined Tibetan characters stored in the Tibetan font, the processing device may not determine the target pre-combined Tibetan character, at this time, the processing device can prompt the user about all possible character combinations, and then input the characters beyond the pre-combined Tibetan characters stored in the Tibetan font according to the indication of the user.

The present disclosure has the following beneficial effects: when the user inputs the Tibetan characters through the input keys, the initial Tibetan characters corresponding to the input keys are obtained according to the keyboard definition module; and the target pre-combined Tibetan character is determined according to the initial Tibetan characters and the Tibetan font, and then character is output. According to the technical solutions provided by the embodiment of the present disclosure, when each storage unit stores a plurality of Tibetan characters, the preset ambiguous layout rule is satisfied, therefore the input module has no redundant code and repeated code, and only 6 very common Tibetan characters correspond to the shift key. Thus, the following problems in the prior art are solved: when one Tibetan character corresponds to one key position, although the Tibetan input method has no repeated code, it contains a large number of redundant codes, namely dead keys; when one Tibetan character corresponds to a plurality of key positions, although it is easy to remember, there are repeated codes; and when a plurality of common Tibetan characters correspond to the shift key position of the keyboard, although there is no repeated code, a large number of shift key positions are present, so the Tibetan input efficiency is relatively low.

The order of the above embodiments is only for the purpose of convenient description, and does not represent the advantages and disadvantages of the embodiments.

Finally, it should be noted that the above embodiments are merely used for illustrating, rather than limiting the technical solutions of the present disclosure; although the present disclosure has been described in detail with reference to the foregoing embodiments, those of ordinary skill in the art should understand that they could still make modifications to the technical solutions recorded in the foregoing embodiments or make equivalent substitutions to a part of technical features therein; and these modifications or substitutions do not make the essence of the corresponding technical solutions depart from the spirit and scope of the technical solutions of the embodiments of the present disclosure.

1. A Tibetan input system, comprising:
an input module, comprising 47 input keys and used by a user for inputting Tibetan characters;
a keyboard definition module, comprising a plurality of storage units, wherein each storage unit corresponds to one input key, and stores one or more Tibetan characters; when each storage unit stores a plurality of Tibetan characters, a preset ambiguous layout rule is satisfied;
a Tibetan font, used for storing pre-combined Tibetan characters; and
a processing device, which is respectively connected with the input module, the keyboard definition module and the Tibetan font, and is used for obtaining initial Tibetan characters corresponding to the input keys according to the keyboard definition module when the user inputs the Tibetan characters through the input keys, determining a target pre-combined Tibetan character according to the initial Tibetan characters and the Tibetan font, and outputting the target pre-combined Tibetan character.

2. The Tibetan input system of claim 1, wherein the processing device comprises:
a mapping module, used for obtaining the initial Tibetan characters corresponding to the input keys according to the keyboard definition module when the user inputs the Tibetan characters through the input keys;
a first storage module, connected with the mapping module, and used for storing the initial Tibetan characters;
a search processing module, connected with the first storage module, and used for using the initial Tibetan character as the target pre-combined Tibetan character when one initial Tibetan character exists, and outputting the target pre-combined Tibetan character; and
the search processing module is further used for obtaining the Tibetan characters that are input in front of or behind the initial Tibetan characters when a plurality of initial Tibetan characters exist, searching the Tibetan font according to the Tibetan characters that are input in front of or behind the initial Tibetan characters and the initial Tibetan characters, determining the target pre-combined Tibetan character from the plurality of initial Tibetan characters, and outputting the target pre-combined Tibetan character.

3. The Tibetan input system of claim 1, wherein the preset ambiguous layout rule comprises:
Tibetan superscripts and Tibetan radicals correspond to two storage units;
Tibetan subscripts and Tibetan postscripts correspond to two storage units;
when the intersection of a set consisting of all prescripts of the Tibetan superscripts and a set consisting of all radicals of the Tibetan subscripts is a null set, the Tibetan superscripts and the Tibetan subscripts can correspond to one storage unit;
when Tibetan consonants cannot be spelled with the prescripts and the Tibetan consonants cannot be used as the postscripts, the Tibetan consonants and Tibetan vowels can correspond to one storage unit; and
when the intersection of a set consisting of all prescripts of other Tibetan radicals excluding the Tibetan radicals corresponding to the consonants that can be used as the postscripts and a set consisting of all radicals of the Tibetan subscripts is a null set, the other Tibetan radicals and the Tibetan subscripts can correspond to one storage unit.

4. The Tibetan input system of claim 3, wherein,
the Tibetan consonant [symbol] and the Tibetan subscript [symbol] correspond to one storage unit, the Tibetan consonant [symbol] and the Tibetan vowel [symbol] correspond to one storage unit, the Tibetan consonant [symbol] and the Tibetan vowel [symbol] correspond to one storage unit, the Tibetan consonant [symbol] and the Tibetan vowel [symbol] correspond to one storage unit, the Tibetan consonant [symbol] and the Tibetan subscript [symbol] correspond to one storage unit, the Tibetan consonant [symbol] and the Tibetan subscript [symbol] correspond to one storage unit, the Tibetan consonant [symbol] and the Tibetan subscript [symbol] correspond to one storage unit, and the Tibetan consonant [symbol] and the Tibetan subscript [symbol] correspond to one storage unit.

5. The Tibetan input system of claim 4, wherein,
among the other Tibetan characters excluding the Tibetan consonant [symbol] , the Tibetan subscript [symbol] , the Tibetan consonant [symbol] , the Tibetan vowel [symbol] , the Tibetan consonant [symbol] , the Tibetan vowel [symbol] , the Tibetan consonant [symbol] , the Tibetan vowel [symbol] , the Tibetan consonant [symbol] , the Tibetan subscript [symbol] , the Tibetan consonant [symbol] , the Tibetan subscript [symbol] , the Tibetan consonant [symbol] , the Tibetan subscript [symbol] , the Tibetan consonant [symbol] and the Tibetan subscript [symbol] , each Tibetan character corresponds to one storage unit.

6. The Tibetan input system of claim 4, wherein,
the input module is further used by the user for inputting an instruction;
the storage unit further stores an instruction character, and the instruction character comprises one or more of a control character Ctrl, an alternate shift character Alt, a shift conversion character Shift, a carriage return character Enter, a backspace character Backspace, a tab character Tab and a capslock character Capslock; and
the processing device is further used for obtaining the instruction character corresponding to the input key according to the keyboard definition module when the user inputs the instruction through the input key, and executing the instruction corresponding to the instruction character.

7. A Tibetan input method, comprising:
S10, detecting whether a plurality of preset input keys are pressed down;
S20, when the input keys are pressed down, obtaining initial Tibetan characters corresponding to the input keys according to a preset keyboard definition module, wherein the keyboard definition module comprises a plurality of storage units, each storage unit corresponds to one input key, and stores one or more Tibetan characters; when each storage unit stores a plurality of Tibetan characters, a preset ambiguous layout rule is satisfied; and
S30, determining a target pre-combined Tibetan character according to the initial Tibetan characters and a preset Tibetan font, and outputting the target pre-combined Tibetan character.

8. The Tibetan input method of claim 7, wherein the S30 comprises:
S301, judging whether one or a plurality of initial Tibetan characters exist; when one initial Tibetan character exists, executing S302; when a plurality of initial Tibetan characters exist, executing S303;
S302, using the initial Tibetan character as the target pre-combined Tibetan character and outputting the target pre-combined Tibetan character;
S303, obtaining the Tibetan characters that are input in front of or behind the initial Tibetan characters; and
S304, searching the Tibetan font according to the Tibetan characters that are input in front of or behind the initial Tibetan characters and the initial Tibetan characters, determining the target pre-combined Tibetan character from the plurality of initial Tibetan characters, and outputting the target pre-combined Tibetan character.

9. The Tibetan input method of claim 7, wherein the preset ambiguous layout rule comprises:
Tibetan superscripts and Tibetan radicals correspond to two storage units;
Tibetan subscripts and Tibetan postscripts correspond to two storage units;
when the intersection of a set consisting of all prescripts of the Tibetan superscripts and a set consisting of all radicals of the Tibetan subscripts is a null set, the Tibetan superscripts and the Tibetan subscripts can correspond to one storage unit;
when Tibetan consonants cannot be spelled with the prescripts and the Tibetan consonants cannot be used as the postscripts, the Tibetan consonants and Tibetan vowels can correspond to one storage unit; and
when the intersection of a set consisting of all prescripts of other Tibetan radicals excluding the Tibetan radicals corresponding to the consonants that can be used as the postscripts and a set consisting of all radicals of the Tibetan subscripts is a null set, the other Tibetan radicals and the Tibetan subscripts can correspond to one storage unit.

10. The Tibetan input method of claim 9, wherein,
the Tibetan consonant [symbol] and the Tibetan subscript [symbol] correspond to one storage unit, the Tibetan consonant [symbol] and the Tibetan vowel [symbol] correspond to one storage unit, the Tibetan consonant [symbol] and the Tibetan vowel [symbol] correspond to one storage unit, the Tibetan consonant [symbol] and the Tibetan vowel [symbol] correspond to one storage unit, the Tibetan consonant [symbol] and the Tibetan subscript [symbol] correspond to one storage unit, the Tibetan consonant [symbol] and the Tibetan subscript [symbol] correspond to one storage unit, the Tibetan consonant [symbol] and the Tibetan subscript [symbol] correspond to one storage unit, and the Tibetan consonant [symbol] and the Tibetan subscript [symbol] correspond to one storage unit.
